(19) United States
(12) Patent Application Publication
(10) Pub. No.: US 2007/0194268 A1
(43) Pub. Date: Aug. 23, 2007

(54) Method of production of dielectric powder, composite electronic device, and method of production of same

(75) Inventors: Masami Endo, Narita-shi (JP); Hiroshi Momoi, Nikaho-shi (JP); Takashi Suzuki, Narita-shi (JP); Takahiro Sato, Ichikawa-shi (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/585,201

(22) Filed: Oct. 24, 2006

(30) Foreign Application Priority Data
Oct. 24, 2005 (JP) 2005-308836

(51) Int. Cl. C01G 49/08

(52) U.S. Cl. 252/62.56

(57) ABSTRACT

A method of production of dielectric powder containing as main ingredients Ti, Cu, and Ni, comprising a step of mixing an oxide of Ti and/or a compound forming an oxide of Ti by firing, an oxide of Cu and/or a compound forming an oxide of Cu by firing, and an oxide of Ni and/or a compound forming an oxide of Ni by firing to obtain a mixed powder, a step of calcining the mixed powder to obtain a calcined powder, a step of dry crushing the calcined powder to obtain dry crushed powder, and a step of wet crushing the dry crushed powder.

### BACKGROUND OF THE INVENTION

1. Field of the Invention

The present invention relates to a method of production of dielectric powder serving as a material for dielectric layers of various types of electronic devices, a method of production of a composite electronic device using this dielectric powder, and a composite electronic device obtained by this method of production.

2. Description of the Related Art

Along with the increasing demand for reduction of the size and weight of electronic apparatuses in which electronic devices are incorporated, the demand for small sized multilayer electronic devices has increased. Further, pluralities of such electronic device are mounted on the circuit boards. Along with this, nultilayer filters, a type of composite electronic device combining a coil and capacitor, have started to be used to deal with the high frequency noise of circuit boards.

Since such a multilayer filter is an electronic device simultaneously having a coil part and a capacitor part. In its process of production, the ferromagnetic material forming the coil part and the dielectric ceramic composition forming the capacitor part have to be simultaneously fired. In general, the ferrite used as the ferromagnetic material forming the coil part has a sintering temperature of a low 800 to 900° C. For this reason, the material forming the dielectric ceramic composition used for the capacitor part of a multilayer filter is required to be able to be sintered at a low temperature.

As dielectric ceramic compositions improved in low temperature sinterability, dielectric ceramic compositions containing TiO₂, CuO, NiO, MnO₃, and Ag₂O (for example, Japanese Patent Publication (B2) No. 8-8198 and Japanese Patent No. 2504725), dielectric ceramic compositions containing TiO₂, ZrO₂, CuO, and MnO₃ (for example, Japanese Patent No. 3272740), dielectric ceramic compositions further containing NiO (for example, Japanese Patent No. 2977632), etc. have been proposed.

On the other hand, along with the further reduction of size of electronic apparatuses in recent years, multilayer filters are also being required to be made smaller in size and lower in profile. As the method for reducing the size and lowering the profile of a multilayer filter while maintaining its performance, the method of reducing the size and thickness of the coil part or the method of reducing the size and thickness of the capacitor part may be considered.

For the coil part, this can be dealt with by reducing the thickness of the ferromagnetic layers and coil conductors and increasing the number of turns of the coil conductors, so the thickness can be reduced relatively easily. However, for the capacitor part, if just reducing the thicknesses of the dielectric layers and internal electrodes and increasing the number stacked, the distance between the internal electrodes will become shorter. Due to this and other factors, the reliability will tend to remarkably fall. Therefore, there has been a limit to the reduction in thickness of the dielectric layers.

In particular, in a multilayer filter for low frequency (for example 10 to 300 MHz) noise, it is considered necessary to raise the electrostatic capacity of the capacitor part while maintaining the inductance of the coil part high. As the method of raising the electrostatic capacity of the capacitor part, the method of raising the specific permittivity of the dielectric ceramic composition used for the dielectric layers or the method of reducing the thicknesses of the dielectric layers and internal electrodes may be considered. However, the dielectric ceramic composition which can be used for a multilayer filter, for the reasons explained above, has to have low temperature sinterability. The selection of such materials is limited. Further, if simply reducing the thicknesses of the dielectric layers and internal electrodes, the average lifetime under a DC field deteriorates and the reliability ends up dropping. Therefore, for such reasons, reduction of the size and thickness of the capacitor parts of multilayer filters has not been realized and, for this reason, there has not been much progress in reducing the size of multilayer filters.

As opposed to this, the assignee previously proposed in Japanese Patent Publication (A) No. 2005-183702 a multilayer filter having specifically designed dielectric layers as dielectric layers forming the capacitor part. That is, it proposed a multilayer filter having dielectric layers containing an oxide of Ti, an oxide of Cu, and an oxide of Ni as main ingredients, having an Ni dispersion of 80% or less, having an average particle size of dielectric particle forming the dielectric layer of 2.5, μm or less, and having a standard deviation a of particle size distribution of 0.5 μm or less. Further, this publication discloses that the dielectric layers can be reduced in thickness to 30 μm or less.

However, on the other hand, if further reducing the thickness of the dielectric layers to for example 15 μm or less by reducing the thickness of the prefiring dielectric green sheets to 20 μm or less, the following inconvenience occurred. That is, dielectric powder aggregating due to calcining ended up remaining at the sheet surface at the time of formation into sheets. This led to a deterioration of the sinterability and resulted in the reliability deteriorating. For this reason, the problem has remained of the difficult further reduction of the thickness of the dielectric layers.

### SUMMARY OF THE INVENTION

An object of the present invention is to provide a method for production of dielectric powder used as a material of the dielectric layers of a composite electronic device such as a multilayer filter able to give a composite electronic device having a high reliability (for example, a high IR, superior IR lifetime composite electronic device) even when reducing the thickness of the green sheets forming the dielectric layers after firing. Another object of the present invention is to provide a method of production of a composite electronic device reduced in size and lowered in profile by using such a dielectric powder and a composite electronic device obtained by this method of production.

To achieve the above objects, the inventors engaged in in-depth studies and as a result discovered that the objects could be achieved by producing the dielectric powder forming the material of the dielectric layers forming a multilayer filter or other composite electronic device by employing the method of calcining the material, then first dry crushing the obtained calcined powder before wet crushing it and thereby completed the present invention.

That is, the method of production of dielectric powder of the present invention is a method of production of dielectric powder containing as main ingredients Ti, Cu, and Ni comprising

a step of mixing an oxide of Ti and/or a compound forming an oxide of Ti by firing, an oxide of Cu and/or a compound forming an oxide of Cu by firing, and an oxide of Ni and/or a compound forming an oxide of Ni by firing to obtain a mixed powder,

a step of calcining the waxed powder to obtain a calcined powder,

a step of dry crushing the calcined powder to obtain dry crushed powder, and
a step of wet crushing the dry crushed powder.

Preferably, the dry crushing is airflow crushing using high pressure air to crush the calcined powder.

In airflow crushing, the calcined powder is crushed directly by collision with high pressure air or is crushed by the flow of the high pressure air causing the particles to collide with each other.

A D90 size of the dry crushed powder after dry crushing is preferably 0.60 μm to 0.80 μm in range, more preferably 0.65 μm to 0.75 μm in range.

A D50 size of the dry crushed powder after dry crushing is preferably 0.45 μm to 0.65 μm in range, more preferably 0.50 to 0.60 μm in range.

The dry crushed powder after dry crushing has a content of coarse particles having a 20 μm or more particle size, by weight ratio with respect to the dry crushed powder as a whole, of preferably 50 ppm or less, more preferably 20 ppm or less.

Preferably, the oxide of Ti and/or compound forming an oxide of Ti by firing is one having a ratio of content of SiO₂ of 20 ppm or less.

The method of production of a composite electronic device of the present invention is a method of production of a composite electronic device having a coil part comprised of coil conductors and ferromagnetic layers and a capacitor part comprised of internal electrodes and dielectric layers, comprising

a step of forming dielectric green sheets forming the dielectric layers after firing and

a step of firing a green chip containing the dielectric green sheets, wherein

the material forming the dielectric green sheets is a dielectric powder obtained by any of the above methods.

In the method of production of the composite electronic device of the present invention, the dielectric green sheets have a thickness of preferably 20 μm or less, more preferably 15 μm or less.

The composite electronic device according to the present invention is obtained by any of the above methods and has a coil part comprised of coil conductors and ferromagnetic layers and a capacitor part comprised of internal electrodes and dielectric layers, the dielectric layers containing as main ingredients an oxide of Ti, an oxide of Cu, and an oxide of Ni and having a thickness of 15 μm or less.

In the composite electronic device of the present invention, the dielectric layers have a content of SiO₂, by weight ratio with respect to the dielectric layers as a whole, of preferably 200 ppm or less, more preferably 100 ppm or less.

In the composite electronic device of the present invention, preferably, the dielectric layers have an Ni dispersion of 80% or less, and the dielectric layers are formed by dielectric crystal particles having an average crystal particle size of 2.5 μm or less and having a standard deviation a of distribution of crystal particle size of 0.5 μm or less. By making the Ni dispersion of the dielectric layers and the standard deviation a of particle size distribution of the dielectric crystal particles forming the dielectric layers the above ranges, the IR lifetime can be further improved.

In the composite electronic device of the present invention, preferably, the dielectric layers further include an oxide of Mn, the content of the oxide of Mn being, with respect to the dielectric layers as a whole as 100 wt %, converted to MnO, more than 0 wt % to 3 wt %.

In the composite electronic device of the present invention, preferably the ferromagnetic layers are comprised of an Ni—Cu—Zn-based ferrite or Cu—Zn-based ferrite.

The composite electronic device according to the present invention is not particularly limited, but a nultilayer filter, multilayer noise filter, etc. may be illustrated.

According to the present invention, when producing the dielectric powder used as the material of the dielectric layers of the multilayer filter or other composite electronic device, the step is employed of calcining it, then first dry crushing (for example, airflow crushing) it, and only then wet crushing it. For this reason, the amount of coarse particles aggregated due to the calcining in the obtained dielectric powder can be reduced. Further, as a result, when using the dielectric powder obtained by the method of the present invention to form dielectric green sheets, even when reducing the thickness of the dielectric green sheets (for example, to 20 μm or less), the sheet surfaces will not have any coarse particles present on them. For this reason, it is possible to effectively prevent sintering defects caused by the presence of coarse particles on the sheet surfaces and as a result a high reliability composite electronic device (for example, a high IR, long IR lifetime composite electronic device) can be obtained.

Note that in the past, the calcined powder obtained by calcining was directly wet crushed without dry crushing. For this reason, if reducing the thickness of the dielectric green sheets, coarse particles aggregating due to the calcining ended up remaining at the sheet surfaces at the time of forming the sheets. This led to a deterioration of the sinterability and resulted in deterioration of the reliability. The present invention solves this problem.

Further, in the present invention, preferably, by using an oxide of Ti and/or compound forming an oxide of Ti by firing which contains SiO₂ in a ratio of content of 20 ppm or less, it is possible to further improve the sinterability of the dielectric layers forming the composite electronic device and possible to further raise the reliability of the composite electronic device.

### BRIEF DESCRIPTION OF THE DRAWINGS

Below, embodiments of the present invention will be explained in detail based on the drawings, wherein:

FIG. 1 is a perspective view of a multilayer filter according to an embodiment of the present invention,

FIG. 2 is a cross-sectional view of a multilayer filter along the line II-II of FIG. 1,

FIG. 3 is a disassembled perspective view of a stacked structure of a multilayer filter according to an embodiment of the present invention,

FIG. 4A is a schematic cross-sectional view of an airflow crusher according to an enbodiment of the present invention, FIG. 4B is a cross-sectional view of principal parts of an airflow crusher along the line IVb-IVb of FIG. 4A,

FIG. 5A is a circuit diagram of a T-type circuit, FIG. 5B is a circuit diagram of an π-type circuit, and FIG. 5C is a circuit diagram of an L-type circuit,

FIG. 6 is a perspective view of a multilayer filter according to another embodiment of the present invention,

FIG. 7 is a disassembled perspective view of the stacked structure of a multilayer filter according to another embodiment of the present invention,

FIG. 8 is a graph of the particle size distribution of dielectric powder in an example of the present invention,

FIG. 9A is a photograph of the surface of a dielectric green sheet according to an example of the present invention, FIG. 9B is a photograph of the surface of a dielectric green sheet according to a comparative example,

FIG. 10A is a photograph of the cross-section of a dielectric layer according to an example of the present invention, FIG. 10B is a photograph of the cross-section of a dielectric layer according to a comparative example, and

FIG. 11A is an enlarged photograph of the cross-section of a dielectric layer according to an example of the present invention, FIG. 11B is an enlarged photograph of the cross-section of a dielectric layer according to a comparative example.

### DESCRIPTION OF THE PREFERRED EMBODIMENTS

### Multilayer Filter 1

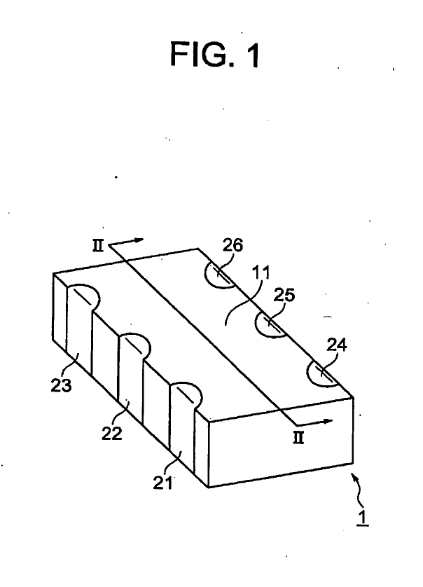

As shown in FIG. 1, a multilayer filter 1 according to an embodiment of the present invention has a main stack 11 as its main part, external electrodes 21, 22, 23 at the left side face in the illustration, and external electrodes 24, 25, 26 at the right side face in the illustration. The multilayer filter 1 is not particularly limited in shape, but usually is a rectangular parallelopiped. Further, the dimensions are not particularly limited and may be made dimensions suitable for the application, but usually are (0.6 to 5.6 mm)×(0.3 to 5.0 mm)×(0.3 to 1.9 mm) or so. First, the structure of the multilayer filter according to the present embodiment will be explained.

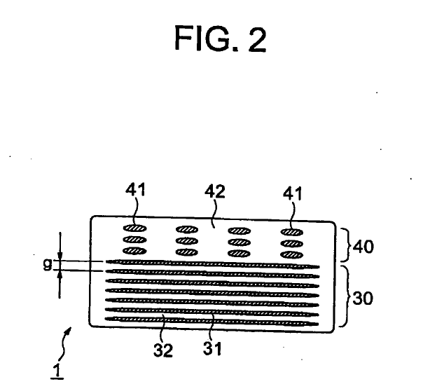

FIG. 2 is a cross-sectional view of a multilayer filter 1 along the line II-II of FIG. 1. The multilayer filter according to the present embodiment has a bottom part formed by a capacitor part 30 and a top part forced by a coil part 40. The capacitor part 30 s comprised of a plurality of internal electrodes 31 between which a plurality of dielectric layers 32 are formed and thereby forms a multilayer capacitor. On the other hand, the coil part 40 is comprised of ferromagnetic layers 42 in which coil conductors 41 having predetermined patterns are formed.

The dielectric layers 32 forming the capacitor part 30 contains a dielectric ceramic composition. The dielectric ceramic composition contains as main ingredients an oxide of Ti, an oxide of Cu, and an oxide of Ni. Further, in accordance with need, other sub ingredients may be suitably added.

The content of the oxide of Ti in the main ingredient is, converted to TiO₂, preferably 50 to 99.5 mol %. If the oxide of Ti is too small in content, the specific permittivity tends to fall.

The oxide of Cu in the main ingredient has the effect of improving the sinterability and the effect of increasing the specific permittivity. The content of the oxide of Cu is, converted to CuO, preferably 0.5 to 50 mol %. If the oxide of Cu is too large in content, the loss Q value tends to deteriorate. On the other hand, if too small, the above effects tend to no longer be obtained.

The oxide of Ni in the main ingredient has the effect of improving the loss Q. The content of the oxide of Ni is, converted to NiO, preferably 0 to 20 mol % (0 mol % not included), further preferably 0.5 to 20 mol %. If the oxide of Ni is too large in content, the sinterability tends to fall and the specific permittivity tends to fall. On the other hand, if too small, the above effect tends to no longer be obtained.

Further, the dielectric ceramic composition preferably contains, in addition to the above main ingredients, an oxide of Mn as a sub ingredient. An oxide of Mn has the effect of improving the sinterability and the effect of increasing the specific permittivity. The content of the oxide of Mn is, with respect to the dielectric ceramic composition as a whole as 100 wt %, converted to MnO, preferably more than 0 wt % to 3 wt %. If the oxide of Mn is too large in content, the loss Q value tends to deteriorate. On the other hand, if too small, the above effects tend to no longer be obtained.

Further, the dielectric ceramic composition preferably has a content of SiO₂, by weight ratio with respect to the dielectric ceramic composition as a whole, suppressed to 200 ppm or less, more preferably 100 ppm or less. By making the content of SiO₂ the above range, the sinterability of the dielectric ceramic composition can be improved, the density of the dielectric ceramic composition can be increased, and as a result the invasion of the plating solution when plating the external electrode surfaces can be effectively prevented. Further, problems due to the invasion of the plating solution (for example, the segregation of the CuO in the dielectric ceramic composition and the resultant ease of diffusion of the silver of the internal conductors into the dielectric ceramic composition, the invasion of the plating solution at those parts and the resultant ease of occurrence of IR defects etc.) can be prevented and the IR lifetime can be improved. Note that as a method for making the content of SiO₂ in the dielectric ceramic composition the above predetermined range, the method of using as the TiO₂ material for forming the dielectric ceramic composition a TiO₂ material reduced in content of SiO₂ to 20 ppm or less may be mentioned. However, a dielectric ceramic composition generally ends up with SiO₂ mixed into it during the process of production (specifically, due to the crushing media in the crushing step) Further, as a result, the fired dielectric ceramic composition ends up containing a greater amount of SiO₂ than the amount contained in the material. For this reason, the above content of SiO₂ in the dielectric ceramic composition is the content including also the SiO₂ mixed in during the process of production. Note that the amount of SiO2 mixed in during the process of production is usually 160 to 200 ppm or so.

Each of the dielectric layers 32 at the parts sandwiched between the pairs of internal electrode layers 31 has thickness (g) of preferably 15 μm or less, more preferably 10 μm or less. In the present embodiment, the dielectric material forming the dielectric layers 32 is a predetermined dielectric powder obtained by the method explained later, so the presintering dielectric green sheets forming the dielectric layers 32 after firing can be reduced in thickness. For this reason, as a result, the sintered dielectric layers 32 can be reduced in thickness in the above way.

The sintered dielectric crystal particles forming the dielectric layers have an average crystal particle size of preferably 2.5 μm or less, more preferably 2 μm or less. The lower limit of the average crystal particle size is not particularly limited, but usually is 0.5 μm or so. If the dielectric crystal particles are too large in average crystal particle size, the insulation resistance tends to deteriorate.

Further, in the present embodiment, the sintered dielectric crystal particles have a standard deviation a of distribution of the crystal particle size of preferably 0.5 μm or less, more preferably 0.45 μm or less, furthermore preferably 0.4 μm or less. The lower the standard deviation a of the distribution of crystal particle size of the dielectric crystal particles, the better. If the standard deviation a of the distribution of crystal particle size of the dielectric crystal particles is over 0.5 μm, the insulation resistance tends to deteriorate.

The average crystal particle size and the standard deviation σ of the distribution of crystal particle size of the dielectric crystal particles can for example be calculated by slicing a dielectric layer 32, examining its cut surface by an SEM, measuring the crystal particle sizes of the dielectric crystal particles, and using the measurement results. Note that the crystal particle sizes of the dielectric crystal particles can for example be found by a code method assuming the crystal particles to be spherical. Further, when calculating the average crystal particle size and standard deviation σa, the number of particles used for measurement of the crystal particle size is usually 100 or more.

Further, in the present embodiment, the dielectric layers 32 have an Ni dispersion of preferably 80% or less, more preferably 70% or less, furthermore preferably 60% or less. The lower the Ni dispersion of the dielectric layers 32, the better. If the Ni dispersion of the dielectric layers 32 is over 80%, the IR lifetime characteristic deteriorates and the reliability tends to fall.

Note that the Ni dispersion (CV value) can be found by analyzing of the cut surface of a dielectric layer 32 by EPMA. (Electron Probe Micro Analysis), preparing a histogram of the count of the spectra of the Ni element, finding that standard deviation σ and average value x, and finding by “CV (%)=(standard deviation σ/average value x)×100 ”.

The internal electrodes 31 forming the capacitor part 30 are not particularly limited in conductive material, but use of silver is preferable.

The internal electrodes 31 are not particularly limited in thickness. The thickness may be suitably set in accordance with the thickness of the dielectric layers 32. The ratio with respect to the thickness of the dielectric layers is preferably 35% or less, more preferably 30% or less. By making the thickness of the internal electrodes 31 35% or less, further 30% or less, of the thickness of the dielectric layers 32, it becomes possible to effectively prevent the “delamination” phenomenon of the layers peeling apart. In particular, by making it 30% or less, the rate of occurrence of delamination can be made substantially 0%. The ferromagnetic layers 42 forming the coil part 40 contain a ferromagnetic material. The ferromagnetic Material is not particularly limited, but preferably is a ferrite containing as its main ingredients an oxide of Ni, an oxide of Cu, an oxide of Zn, or an oxide of Mn, etc. As this ferrite, for example, an Ni—Cu—Zn-based ferrite, Cu—Zn-based ferrite, Ni—Cu-based ferrite, Ni—Cu—Zn—Mg-based ferrite, etc. may be mentioned. Among these, an Ni—Cu—Zn-based ferrite or Cu—Zn-based ferrite is preferably used. Note that the ferromagnetic layers 42 may also contain, in addition to the above main ingredients, sub ingredients in accordance with need.

The conductive material contained in the coil conductors 41 forming the coil part 40 may be the same material as the internal electrodes 31.

The external electrodes 21 to 26 are not particularly limited, but silver electrodes may be used. These silver electrodes are preferably plated by Cu—Ni—Sn, Ni—Sn, Ni—Au, Ni—Ag, etc.

Method of Production of Multilayer Filter 1

The multilayer filter of the present embodiment, in the same way as a conventional multilayer filter, is produced by preparing dielectric green sheets and ferromagnetic green sheets, stacking these green sheets to form a green main stack 11, firing this, then forming external electrodes 21 to 26. Below, the method of production will be specifically explained.

Production of Dielectric Green Sheets

First, the dielectric powder forming the material of the dielectric layers 32 is prepared.

In the present embodiment, this dielectric powder is prepared by the following method. That is, first, the materials of the main ingredients and sub ingredients are mixed and dispersed, then the mixture is spray dried, then calcined to obtain calcined powder. Further, the obtained calcined powder is first dry crushed (airflow crushed), then the obtained crushed powder is further wet crushed and finally spray dried. Below, the method of preparation of the dielectric powder will be explained in detail.

First, the-main ingredient materials and sub ingredient materials forming the dielectric powder are prepared.

As the main ingredient materials, oxides of Ti, Cu, or Ni (for example, TiO₂, NiO, or CuO) or their mixtures or complex oxides may be used, but it is also possible to suitably select and mix for use various types of compounds formng the oxides or complex oxides after firing such as carbontes, oxalates, nitrates, hydroxides, organometallic compounds, etc.

Note that in the present embodiment, the oxide of Ti and/or compound forming an oxide of Ti by firing (TiO₂ etc.) preferably is one having a ratio of content of SiO₂ of 20 ppm or less. By using a material reduced in content of SiO₂ in this way, the dielectric powder can be improved in sinterability and the invasion of the plating solution into the element body (main stack) at the tire of formation of the external electrodes can be effectively prevented.

Further, the sub ingredient materials may be suitably prepared in accordance with the types of sub ingredients to be added. For example, an oxide of Mn (for example, MnO) or compound forming an oxide of Mn firing (for example, MnCO₃) is preferably used.

Next, the prepared main ingredient materials and sub ingredient materials are mixed and dispersed to prepare a mixed powder. The method of mixing and dispersing these materials is not particularly limited, but for example, it is possible to add water, an organic solvent, etc. to the material powder and use a ball mill etc. for wet mixing.

Further, the obtained material powder is spray dried, then calcined to obtain a calcined powder. As the calcining conditions, the holding temperature is preferably 500 to 850° C., more preferably 600 to 850° C., and the temperature holding time is preferably 1 to 15 hours. This calcining may be performed in the air or may be performed in an atmosphere with an oxygen partial pressure higher than the air or in a pure oxygen atmosphere. By calcining under these conditions, the obtained dielectric powder can be improved in Ni dispersion and as a result the dielectric layers 32 can be improved in Ni dispersion.

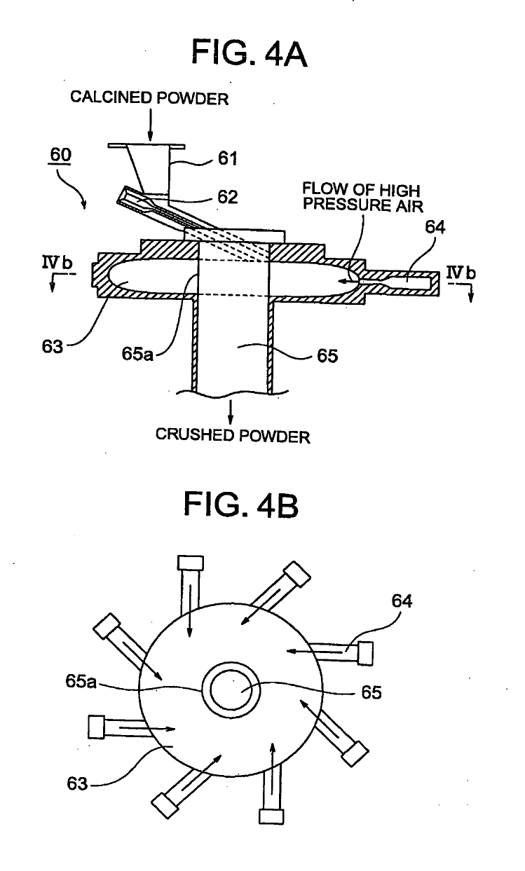

Next, the calcined powder obtained above is airflow crushed (dry crushed) using an airflow crusher 60 shown in FIG. 4A, FIG. 4B to obtain a crushed powder. Note that here, FIG. 4A is a schematic cross-sectional view of the airflow crusher 60, while FIG. 4B is a cross-sectional view of principal parts along the line IVb-IVb of FIG. 4A.

As shown in FIG. 4A, the airflow crusher 60 of the present embodiment is charged with calcined powder into a powder feed hopper 61, feeds the calcined powder from a powder feed nozzle 62 to a crushing chamber 63, crushes the powder at this crushing chamber 63, then discharges the crushed powder through an outlet 65a having a plurality of through holes out from a discharge pipe 65.

Here, as shown in FIG. 4A, FIG. 4B, the crushing chamber 63 is formed with a plurality of air jet nozzles 64 around it. These plurality of air jet nozzles 64 are connected to an air feed pipe (not shown) and can supply high pressure air. Further, the high pressure air supplied from the air jet nozzles 64, as shown in FIG. 4B, is designed to be ejected in the circumferential direction of the crushing chamber 63. This ejection of high pressure air causes the calcined powder fed into the crushing chamber 63 to swirl. The swirling calcined powder can be crushed by collisions between particles and by collision with the high pressure air.

Further, the crushed powder crushed by the high pressure air passes through the outlet 65a having the plurality of through holes and is discharged from the discharge pipe 65. Note that in the present embodiment, the size of the through holes of the outlet 65a can be suitably adjusted so as to control the particle size of the crushed powder after airflow crushing.

The present embodiment has as its most characteristic feature the airflow crushing (dry crushing) of the calcined powder obtained by calcining. By adopting such a configuration, it is possible to prevent coarse particles (for example, particles having a 20 μm or more particle size) from being mixed into the dielectric paste. For this reason, by using dielectric powder obtained by airflow crushing in the above way, it is possible to effectively prevent coarse particles from remaining on the surfaces of the obtained dielectric green sheets. Further, as a result, it is possible to prevent the deterioration of sinterability due to coarse particles remaining on the surfaces of the dielectric green sheets, for example, it is possible to maintain a high reliability even if reducing the thickness of the dielectric green sheets to 20 μm or less. That is, even if reducing the thickness of the dielectric green sheets, the IR can be maintained high and the IR lifetime can be improved.

Note that in the past, the calcined powder was directly wet crushed without dry crushing. For this reason, if reducing the thickness of the dielectric green sheets to 20 μm or less, coarse particles aggregating due to the calcining ended up remaining at the sheet surfaces at the time of forming the sheets. This led to a deterioration of the sinterability and resulted in deterioration of the reliability. The present embodiment solves this problem.

In the present embodiment, the airflow crushing is preferably performed so that the crushed powder after the airflow crushing has a D90 size and D50 size within the following ranges.

That is, the D90 size is preferably 0.60 μm to 0.80 μm in range, more preferably 0.65 μm to 0.75 μm in range. If the D90 size is too large, the reduction of thickness of the dielectric green sheets tends to become difficult.

Further, the D50 size is preferably 0.45 μm to 0.65 μm in range, more preferably 0.50 to 0.60 μm in range. If the D50 size is too small, the dielectric powder ends up aggregating and formation into a paste ends up becoming difficult.

Note that in the present embodiment, the “D90 size” means the cumulative 90% particle size from the fine particle side of the cumulative particle size distribution. Similarly, the “D50 size” means the cumulative 50% particle size from the fine particle side of the cumulative particle size distribution. Therefore, for example, when the D90 size is 0.60 μm to 0.65 μm in range, the D50 size is 0.45 μm to less than 0.65 μm in range and a smaller particle size than the D90 size.

Further, the crushed powder after the airflow crushing preferably has a content of coarse particles having a 20 μm or more particle size (residual amount of coarse particles), by weight ratio with respect to the crushed powder after airflow crushing as a whole, reduced to preferably 50 ppm or less, more preferably 20 ppm or less.

Next, the crushed powder obtained by airflow crushing is wet crushed, then spray dried so as to obtain dielectric powder for the material of the dielectric layers 32. The method of wet crushing is not particularly limited, but for example it is possible to add water, an organic solvent, etc. to the crushed powder after the airflow crushing and use a ball mill etc. to wet mix it.

Note that in the present embodiment, the lower the Ni dispersion of the spray dried dielectric powder, the better, and the dispersion is preferably 50% or less, more preferably 45% or less, furthermore preferably 25% or less. If the spray dried dielectric powder has an Ni dispersion over 50%, the IR lifetime characteristic etc. deteriorate and the reliability tends to fall. The Ni dispersion of the prefiring powder of the spray dried dielectric powder is measured by EPMA of the powder surface of the prefiring powder in the same way as the measurement of the Ni dispersion of the dielectric layers 32.

Next, the above prepared dielectric powder is formed into a paste to prepare a dielectric layer paste.

The dielectric layer paste may be an organic-based paste obtained by kneading a prefiring powder and organic vehicle or may be a water-based coating paste.

The internal electrode layer paste is prepared for example by kneading together silver or another conductive material and the above organic vehicle.

The content of the organic vehicle in the above pastes is not particularly limited. A usual content, for example, in the case of the dielectric layer paste, of a binder of 5 to 15 wt % or so and a solvent of 50 to 150 wt % or so with respect to the dielectric powder as 100 wt % may be used. Further, the pastes may further contain, in accordance with need, additives selected from various types of dispersants, plasticizers, etc. The total content is preferably 10 wt % or less in each case.

Alternatively, the internal electrode layer paste may be prepared by adding a binder, solvent, etc. in the above ratios with respect to the conductive material as 100 wt %.

Next, the dielectric layer paste is formed into sheets by the doctor blade method etc. so as to form the dielectric green sheets.

The dielectric green sheets have a thickness reduced to preferably 20 μm or less, more preferably 15 μm or less. In the present embodiment, the dielectric powder obtained by the above method is used, so even if reducing the thickness of the dielectric green sheets in this way, the reliability can be kept high.

Next, the dielectric green sheet is formed with internal electrodes. The internal electrodes are formed by forming internal electrode paste on the dielectric green sheets by screen printing or another method. Note that pattern of formation of the internal electrodes may be suitably selected in accordance with the circuit configuration of the multilayer filter produced etc., but in the present embodiment, the later explained patterns are used.

Production of Ferromagnetic Green Sheets

First, the ferromagnetic material contained in the ferromagnetic layer paste is prepared and converted into a paste to prepare the ferromagnetic layer paste.

The ferromagnetic layer paste may be an organic-based paste obtained by kneading a ferromagnetic material and an organic vehicle or may be a water-based coating paste.

In the ferromagnetic material, as the starting materials of the main ingredients, oxides of Fe, Ni, Cu, Zn, and Mg or various types of compounds forming these oxides after firing, for example, carbonates, oxalates, nitrates, hydroxides, organometallic compounds, etc. may be suitably selected from and mixed for use. Further, the ferromagnetic material may contain, in addition to the main ingredients, starting materials of the sub ingredients in accordance with need.

Note that the starting materials forming the ferromagnetic material may be reacted in advance by calcining etc. before forming the ferromagnetic layer paste.

The coil conductor paste is for example prepared by kneading together silver or another conductive material and the above organic vehicle.

Next, the ferromagnetic layer paste is formed into sheets by the doctor blade method etc. to form ferromagnetic green sheets.

Next, the thus prepared ferromagnetic green sheets are formed with coil conductors. The coil conductors are formed by forming the coil conductor paste on the ferromagnetic green sheets by screen printing or another method. Note that the patterns of formation of the coil conductors may be suitably selected in accordance with the circuit configuration of the multilayer filter produced etc. In the present embodiment, they are made the patterns explained later.

Next, through holes are formed in the coil conductors on the ferromagnetic green sheets. The method of forming the through holes is not particularly limited, but for example they may be formed by laser etc. Note that the positions of formation of the through holes are not particularly limited so long as they are on the coil conductors, but formation at the ends of the coil conductors is preferable. In the present embodiment, they are made the later explained positions.

Stacking of Green Sheets

Next, the above prepared dielectric green sheets and ferromagnetic green sheets are successively stacked to form a green main stack 11.

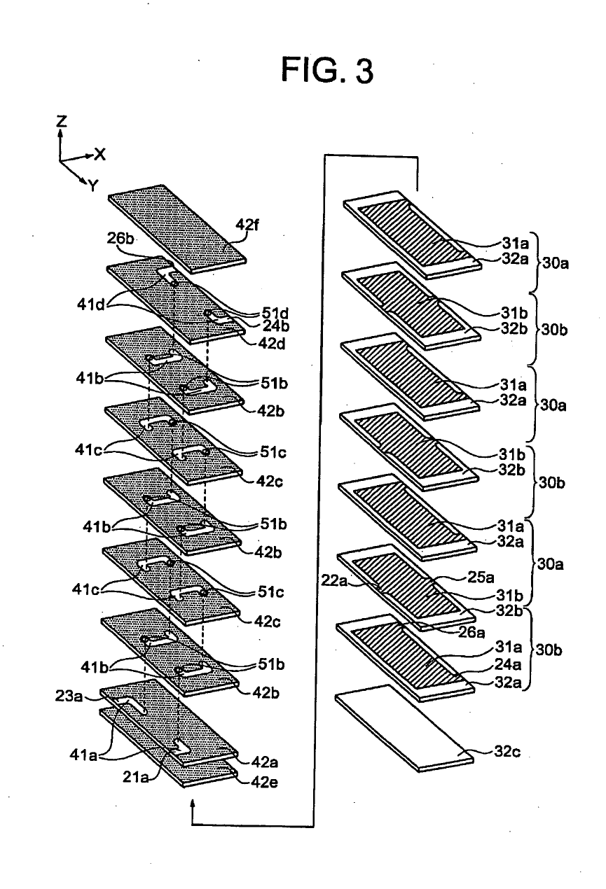

In the present embodiment, the green main stack 11 is produced, as shown in FIG. 3, by stacking a plurality of dielectric green sheets on which internal electrodes are formed for forming the capacitor part and stacking over that a plurality of ferromagnetic green sheets on which coil conductors are formed for forming the coil part.

Below, the step of stacking the green sheets will be explained in detail.

First, at the bottommost layer, a dielectric green sheet 32c not formed with an internal electrode is arranged. The dielectric green sheet 32c not formed with an internal electrode is used for protecting the capacitor part and may be suitably adjusted in thickness.

Next, the dielectric green sheet 32c not formed with an internal electrode has stacked over it a dielectric green sheet 32a formed with an internal electrode 31a having a pair of leadout parts 24a and 26a sticking out from the far side in the short direction X of the dielectric green sheet to the end of the dielectric green sheet.

Next, the dielectric green sheet 32a formed with the internal electrode 31a has stacked over it a dielectric green sheet 32b formed with an internal electrode 31b having a pair of readout parts 22a and 25a sticking out from the near side and far side in the short direction X of the dielectric green sheet to the ends of the dielectric green sheet.

By stacking the dielectric green sheet 32a formed with the internal electrode 31a and dielectric green sheet 32b formed with the internal electrode 31b in this way, a green single-layer capacitor 30b comprised of the internal electrodes 31a, 31b and the dielectric green sheet 32b is formed.

Next, the dielectric green sheet 32b formed with the internal electrodes 31b has stacked over it a dielectric green sheet 32a formed with an internal electrode 31a, whereby similarly a green single-layer capacitor 30a Comprised of the internal electrodes 31a, 31b and the dielectric green sheet 32a is formed.

By similarly alternately stacking dielectric green sheets 32a formed with internal electrodes 31a and dielectric green sheets 32b formed with internal electrodes 31b, it is possible to obtain a capacitor part in which a plurality of green single-layer capacitors 30a and 30b are alternately formed. Note that in the present embodiment, the case is shown of stacking a total of six layers of the single-layer capacitors 30a, 30b, but the number of layers stacked is not particularly limited and may be suitably selected in accordance with the objective.

Next, the thus formed green capacitor part is formed with a green coil part over it.

First, the capacitor part has stacked over it a ferromagnetic green sheet 42e not formed with coil conductors. The ferromagnetic green sheet 42e not formed with coil conductors stacked over the capacitor part is used for the purpose of separating the capacitor part and the coil part and may be suitably adjusted in thickness. Note that in the present embodiment, the case of use of the ferromagnetic green sheet 42e for separating the capacitor part and the coil part is shown, but the ferromagnetic green sheet 42e may also be replaced with use of a dielectric green sheet.

Next, the ferromagnetic green sheet 42e not formed with coil conductors has stacked over it a ferromagnetic green sheet 42a formed with a pair of coil conductors 41a having leadout parts 21a and 23a sticking out at their ends to a near end of the ferromagnetic green sheet in the short direction X.

Further, over that is stacked a ferromagnetic green sheet 42b formed with a pair of substantially C-shaped coil conductors 41b. Note that the substantially C-shaped coil conductors 41b are arranged so that their convex sides face the near side in the long direction Y of the ferromagnetic green sheet. Further, they are formed with through holes 51b at their near ends in the short direction X of the ferromagnetic green sheet.

Further, when stacking the ferromagnetic green sheet 42b formed with the pair of substantially C-shaped coil conductors 41b, a conductor paste is used to electrically connect the coil conductors 41a and the coil conductors 41b through the pair of through holes 51b formed in the ferromagnetic green sheet 42b. Note that the conductor paste used for connection through the through holes is not particularly limited, but silver paste is preferably used.

Next, the ferromagnetic green sheet 42b has stacked over it a ferromagnetic green sheet 42c formed with a pair of coil conductors 41c of patterns reverse to the coil conductors 41b. That is, the ferromagnetic green sheet 42c has the coil conductors 41c arranged so that their convex sides face the far side in the long direction Y of the ferromagnetic green sheet 42c. Further, the coil conductors 41c are formed with a pair of through holes 51c at their far ends in the short direction X of the ferromagnetic green sheet. And, similarly, a conductor paste is used to electrically connect the coil conductors 41b and the coil conductors 41c through these through holes 51c.

In the same way, a plurality of ferromagnetic green sheets 42b formed with coil conductors 41b and ferromagnetic green sheets 42c formed with coil conductors 41c are alternately stacked. Next, the topmost ferromagnetic green sheet 42b formed with coil conductors 41b has stacked over it a ferromagnetic green sheet 42d. This ferromagnetic green sheet 42d is a ferromagnetic green sheet formed with a pair of coil conductors 41d having leadout parts 24b and 26b sticking out at their ends to the far end of the ferromagnetic green sheet 42d in the short direction X. Note that when stacking the ferromagnetic green sheet 42d, a conductor paste is used to electrically connect the coil conductors 41b and the coil conductors 41d through a pair of through holes 51d formed at the near ends of the coil conductors 41d in the short direction X.

Finally, the ferromagnetic green sheet 42d formed with the coil conductors 41d has stacked over it a ferromagnetic green sheet 42f not formed with coil conductors. This ferromagnetic green sheet 42f is used for protecting the coil part and for adjusting the thickness dimension of the nultilayer filter. Its thickness may be suitably adjusted so that the thickness of the multilayer filter becomes a desired thickness.

By connecting the coil conductors on the ferromagnetic green sheets through the through holes in the above way, a coil turning once every two ferromagnetic green sheets is formed.

Firing of Main Stack and Formation of External Electrodes

Next, the green main stack prepared by successively stacking the dielectric green sheets and ferromagnetic green sheets is fired. As the firing conditions, the rate of temperature rise is preferably 50 to 500° C./hour, more preferably 200 to 300° C./hour, the holding temperature is preferably 840 to 900° C., the temperature holding time is preferably 0.5 to 8 hours, more preferably 1 to 3 hours, and the cooling rate is preferably 50 to 500° C./hour, more preferably 200 to 300° C./hour.

Next, the fired main stack is end polished by for example barrel polishing or sand blasting, the two side faces of the main stack are coated and dried with external electrode paste, and the assembly is then fired to thereby form the external electrodes 21 to 26 as shown in FIG. 1. The external electrode paste way for example be prepared by kneading silver or another conductive material and the above mentioned organic vehicle. Note that the thus forced external electrodes 21 to 26 are preferably electroplated by Cu—Ni—Sn, Ni—Sn, Ni—Au, Ni—Ag, etc.

When forming the external electrodes, the external electrodes 21 and 23 are connected with the leadout parts 21a and 23a of the coil part shown in FIG. 3 to form input/output terminals. Further, the external electrode 24 is connected with the readout parts 24a of the capacitor part and the leadout parts 24b of the coil part to form an input/output terminal connecting the capacitor part and coil part. Further, the external electrodes 26 is similarly connected with the leadout parts 26a of the capacitor part and the leadout parts 26b of the coil part to form an input/output terminal of the capacitor part and coil part. The external electrodes 22 and 25 are connected to the leadout parts 22a and 25a of the capacitor part to form ground terminals.

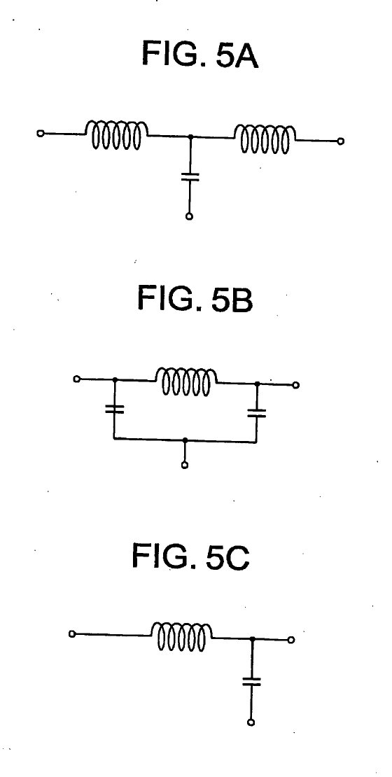

By forming the external electrodes 21 to 26 at the main stack 11 in the above way, the multilayer filter of the present embodiment configures a T-type circuit shown in FIG. 5A.

The thus produced multilayer filter of the present embodiment is mounted by soldering etc. on a printed circuit board etc. and used for various types of electronic apparatuses etc.

While an embodiment of the present invention was explained above, the present invention is not limited to the above-mentioned embodiment in any way and can be modified in various ways within a scope not departing from the gist of the present invention.

For example, in the above-mentioned embodiment, the composite electronic device according to the present invention was illustrated as a nultilayer filter, but the composite electronic device according to the present invention is not limited to a multilayer filter and may be any device having dielectric layers obtained by the above method.

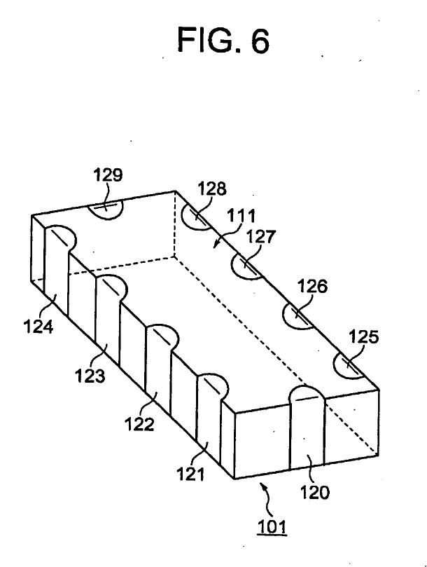

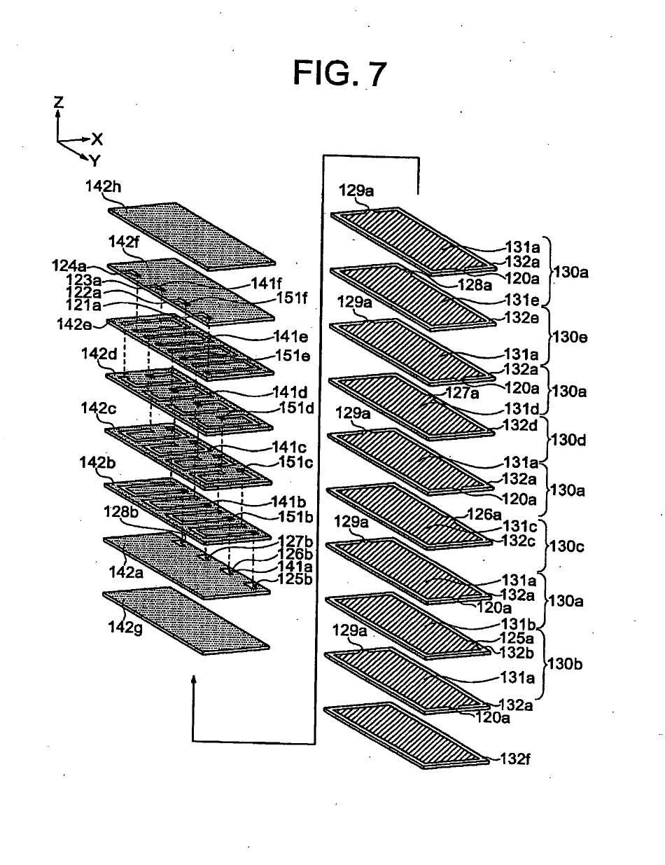

Further, in the above-mentioned embodiment, a multilayer filter formed with a T-type circuit was illustrated, but the multilayer filter may also be formed with other lumped constant circuits. For example, the other lumped constant circuits may be the π-type shown in FIG. 5B, the L-type shown in FIG. 5C, or the double π-type comprised of two π-type circuits. Further, the multilayer filter may be made the multilayer filter 101 comprised of four L-type circuits shown in FIG. 6 and FIG. 7.

In the multilayer filter 101 comprised of four L-type circuits show in FIG. 6 and FIG. 7, the same materials as in the above-mentioned embodiment may be used for forming the dielectric layers and the ferromagnetic layers. Further, the dielectric green sheets and ferromagnetic green sheets may be prepared in the same way as the abovementioned embodiment.

In the multilayer filter shown in FIG. 6 and FIG. 7, the external electrodes 121 to 124 shown in FIG. 6 are connected to the leadout parts 121a to 124a of the coil part shown FIG. 7 to form input/output terminals. Further, similarly, the external electrodes 125 to 128 are connected to the leadout parts 125a to 128a of the capacitor part and the leadout parts 125b to 128b of the coil part to form input/output terminals connecting the capacitor part and coil part. Further, the external electrodes 120, 129 are connected to leadout parts 120a, 129a of the capacitor part to form ground terminals.

Further, the multilayer filter 101 shown in FIG. 6 and FIG. 7 is comprised of four of the L-type circuits shown in FIG. 5C.

### EXAMPLES

Below, the present invention will be explained by further detailed examples, but the present invention is not limited to these examples.

### Example 1

In this example, a dielectric powder and dielectric green sheets were prepared and the obtained dielectric powder and dielectric green sheets were evaluated.

First, as the main ingredient materials for forming the dielectric powder, TiO₂, CuO, and NiO were prepared, while as the sub ingredient material, MnO₃ was prepared. These materials were wet mixed to obtain a mixed powder. The wet mixing was performed by adding pure water to the prepared main ingredient materials and sub ingredient material and mixing these by a ball mill containing zirconia media for 16 hours.

The amounts of the main ingredient materials added were TiO₂: 92 mol %, CuO: 3 mol %, and NiO: 5 mol %, while the amount of the sub ingredient material MnCO₃ added was 1 wt % with respect to the main ingredient materials. Note that in this example, the TiO₂ material used had a content of SiO₂, by weight ratio, of 20 ppm

Further, the mixed powder obtained by the wet mixing was spray dried, then calcined under conditions of a holding temperature of 750° C. and a holding time of 1 hour to obtain a calcined powder.

Next, the obtained calcined powder was airflow crushed (dry crushed) using an airflow crusher (made by Nippon Pneumatic Manufacturing Co., Ltd., PJM) shown in FIG. 4A and FIG. 4B to obtain the crushed powder of this example.

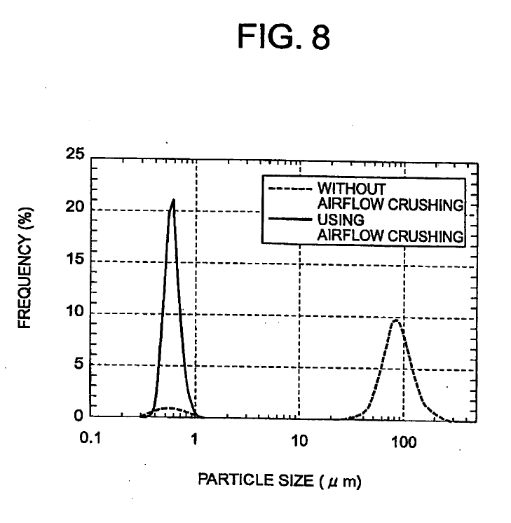

Note that the crushed powder after the airflow crushing had a D90 size of 0.71 μm and a D50 size of 0.56 μm. The results of measurement of the particle size of the crushed powder after the airflow crushing are plotted in the graph of FIG. 8.

Further, the crushed powder after the airflow crushing was measured for content of coarse particles having a 20 μm or more particle size, whereupon this was 4.2 ppm by weight ratio to the crushed powder after the airflow crushing as a whole. The content of the coarse particles in the crushed powder was measured by ultrasonically dispersing 300 g of the obtained dielectric powder while sieving out particles of less than 20 μm, measuring the weight of the particles finally remaining as the residue, and using the obtained result was the weight of the coarse particles.

Next, pure water was added to the crushed powder which was then wet crushed by a ball mill containing zirconia media for 18 hours to form a slurry. The slurry was spray dried to obtain the dielectric powder of this example of the present invention.

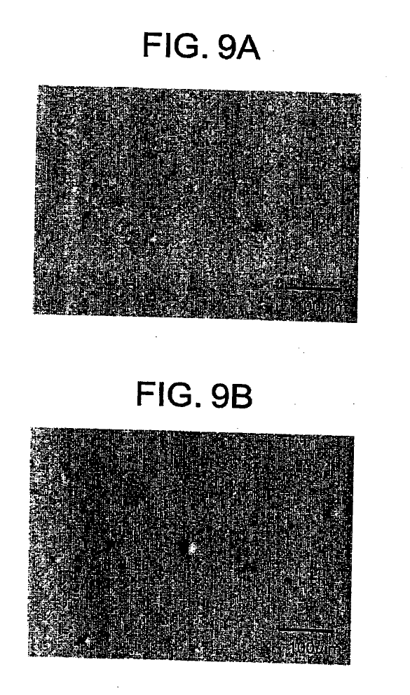

Further, a resin binder, solvent, plasticizer, and dispersant were added to the dielectric powder obtained above and the mixture was spread by the doctor blade method to form dielectric green sheets. Note that the dielectric green sheets were prepared to give a dried thickness of 20 μm. One obtained dielectric green sheet was examined at its surface by a microscope, whereupon no coarse particles could be confirmed present on the surface of the dielectric green sheet, i.e., good results were obtained. Note that the obtained micrograph is shown in FIG. 9A.

### Comparative Example 1

Except for not performing airflow crushing, the same method was used as in Example 1 to produce the dielectric powder of this comparative example.

Note that in Comparative Example 1, no airflow crushing is performed, so the particle size of the calcined powder after calcining (before wet crushing) was measured. The results are shown in FIG. 8.

Next, the obtained calcined powder was further wet crushed by the same method as in Example 1, then was spray dried to obtain the dielectric powder of the comparative example. Next, the same method was used as in Example 1 to produce dielectric green sheets giving a dried thickness of 20 μm Further, one obtained dielectric green sheet was examined at its surface by a microscope, whereupon coarse particles could be confirmed present on the surface of the dielectric green sheet. Note that the obtained micrograph is shown in FIG. 9B.

Evaluation 1

FIG. 8 is a graph showing the particle size distributions of the crushed powder after the airflow crushing according to Example 1 and the calcined powder after calcining according to Comparative Example 1. Note that in this evaluation, to confirm the effect of the airflow crushing, the particle size distributions of the powder after airflow crushing (Example 1) and the powder without airflow crushing (Comparative Example 1) are superposed for comparison.

From FIG. 8, in Example 1 with airflow crushing, the majority of the particles have a size of approximately 1 μm or less. It can be confirmed that there are almost no coarse particles with a particle size of 20 μm or more. As opposed to this, in Comparative Example 1 without airflow crushing, it can be confirmed that there is a large ratio of particles with a particle size of 20 μm or more.

Evaluation 2

By comparing FIG. 9A and FIG. 9B, the following can be confirmed. That is, in Example 1 of the present invention with airflow crushing followed by wet crushing, it can be confirmed that even when reducing the thickness of the dielectric green sheet to 20 μm, a good sheet with no coarse particles on the sheet surface is obtained. On the other hand, in Comparative Example 1 with no airflow crushing and just wet crushing, the result was coarse particles present on the sheet surface. Further, the coarse particles present on the sheet surface became causes of deterioration of the sinterability and, as explained later (see Evaluation 3), probably resulted in deterioration of the average lifetime.

### Example 2

In Example 2, the dielectric green sheets prepared in Example 1 were used by the following method to produce multilayer filters having the configuration shown in FIG. 1 to FIG. 3.

That is, first, the dielectric green sheets prepared by Example 1 were printed with predetermined electrode patterns using an internal electrode paste containing silver as its main ingredient to thereby prepare dielectric green sheets with electrode patterns. In this example, a plurality of dielectric green sheets having electrode patterns were prepared to obtain the different internal electrode patterns shown m FIG. 3.

Next, ferromagnetic green sheets were prepared.

First, as the materials for forming the ferromagnetic material powder, NiO, CuO, ZnO, and Fe₂O₃ were prepared. These materials were blended, then calcined and crushed to prepare the ferromagnetic material powder. Note that the amounts of the materials blended were NiO: 25 mol %, CuO: 11 mol %, ZnO: 15 mol %, and Fb₂O₃: residue.

A resin binder, solvent, plasticizer, and dispersant were added to the obtained ferromagnetic material powder which was then spread by the doctor blade method to prepare ferromagnetic green sheets. Note that the ferromagnetic green sheets had a thickness of approximately 20 μm.

Next, a coil conductor paste having silver as its main ingredient was used to form coil conductors on the ferromagnetic green sheets. Further, a laser was used to form through holes to thereby obtain ferromagnetic green sheets with predetermined conductor patterns and through holes. Note that in this example, a plurality of ferromagnetic green sheets having patterns with coil conductor patterns and through hole positions matching with the patterns and positions shown in FIG. 3 were prepared.

Next, the above prepared plurality of dielectric green sheets and plurality of ferromagnetic green sheets were stacked as shown in FIG. 3 and fired at 890° C. to prepare main stacks. Further, the two side faces of the fired main stacks were coated and dried with external electrode paste, then the assemblies were fired to bake on the external electrodes. Further, finally, the external electrodes were plated on their surfaces with Cu—Ni—Sn to form plating films and thereby prepare multilayer filters such as shown in FIG. 1. Note that the multilayer filters had dimensions of a length of 1.6 mm, a width of 0.8 mm, and a height of 0.8 mm.

The obtained multilayer filters were measured for the thickness of the dielectric layers 32 of the capacitor part, the IR (insulation resistance), and the average lifetime.

Thickness of Dielectric Layers

A sample of a thus prepared multilayer filter was sliced open at a plane perpendicular to the internal electrodes, that cut surface was polished, then the polished surface was examined at a plurality of locations by a metal microscope to measure the thickness of the dielectric layers. As a result, in this example, the dielectric layers had a thickness of 15 μm.

IR (Insulation Resistance)

Samples of the thus prepared multilayer filter were measured for resistance using an insulation resistance meter (HEWLETT PACKARD E2377A Multi meter). In this example, 20 samples were measured and the average was found for the evaluation. The results are shown in Table 1.

Measurement of Average Lifetime

The average lifetime was measured by applying a 20V DC field to samples of the obtained multilayer filters in a 150° C. constant temperature tank. Specifically, the time after which the value of the insulation resistance became 1×10⁶Ω or less was used as the lifetime. 20 samples were tested and the results averaged to obtain the average lifetime. The results are shown in Table 1.

### Comparative Example 2

Except for using the dielectric green sheets prepared in Comparative Example 1, the same procedure was performed as in Example 2 to prepare multilayer filters. The same procedures were performed as in Example 2 to evaluate them. The IR (insulation resistance) and average lifetime are shown in Table 1. Note that in Comparative Example 2, the dielectric layers 32 had a thickness of 15 μm.

### Comparative Example 3

Except for not performing the calcining and airflow crushing when preparing the dielectric powder, the same procedure was performed as in Example 1 to prepare a dielectric powder, then the same procedure was performed as in Example 1 to prepare dielectric green sheets. Further, the obtained dielectric green sheets were used for the same method as in Example 2 to produce multilayer filters which were then evaluated in the same way as Example 2. The IR (insulation resistance) and average lifetime are shown in Table 1. Note that in Comparative Example 3, the dielectric layers 32 had a thickness of 14 μm.

### Comparative Example 4

Except for using as the main ingredient TiO₂ material a TiO₂ containing SiO₂ in a weight ratio of 219 ppm when preparing the dielectric powder and further not performing the airflow crushing, the same procedure was performed as in Example 1 to prepare a dielectric powder, then the same procedure was performed as in Example 1 to prepare dielectric green sheets. Further, the obtained dielectric green sheets were used for the same method as in Example 2 to produce multilayer filters which were then evaluated in the same way as Example 2. The IR (insulation resistance) and average lifetime are shown in Table 1. Note that in Comparative Example 4, the dielectric layers 32 had a thickness of 14 μm.

### Reference Example 1

Except for using as the main ingredient TiO₂ material a TiO₂ containing SiO₂ in a weight ratio of 219 ppm when preparing the dielectric powder, the same procedure was performed as in Example 1 to prepare a dielectric powder, then the same procedure was performed as in Example 1 to prepare dielectric green sheets. Further, the obtained dielectric green sheets were used for the same method as in Example 2 to produce multilayer filters which were then evaluated in the same way as Example 2. The IR (insulation resistance) and average lifetime are shown in Table 1. Note that in Reference Example 1, the dielectric layers 32 had a thickness of 15 μm.

TABLE 1

| | | | SiO₂ | | |
|---|---|---|---|---|---|
| | | | content in | | |
| | | | TiO₂ | | Average |
| | Cal- | Airflow | material | IR | lifetime |
| | cining | crushing | [ppm] | [Ω] | [h] |
| Ex. 2 | Yes | Yes | 20 | 9.8 × 10⁸ | >170 |
| Comp. Ex. 2 | Yes | No | 20 | 9.5 × 10⁸ | 101 |
| Comp. Ex. 3 | No | No | 20 | 5.6 × 10⁹ | 75.2 |
| Comp. Ex. 4 | Yes | No | 219 | 1.1 × 10¹⁰ | 16.9 |
| Ref. Ex. 1 | Yes | Yes | 219 | 1.2 × 10¹⁰ | 124 |

Evaluation 3

From Table 1, in Example 2 using dielectric powder produced by the method of the present invention, the IR lifetime could be kept high while improving the average lifetime to 170 hours or more. Note that Example 2 is an example of using as a TiO₂ material a TiO₂ containing SiO₂ in a content of 20 ppm.

On the other hand, in Comparative Example 2 without airflow crushing and Comparative Example 3 without calcining or airflow crushing, the average lifetime deteriorated and the reliability became poor.

Further, in Comparative Example 4 without airflow crushing and further with the TiO₂ material changed to one with a content of SiO₂ of 219 ppm, the average lifetime became an extremely short 16.9 hours. Note that from the results of Reference Example 1, it can be confirmed that even when performing airflow crushing, if using a TiO₂ material containing SiO₂ in a content of 219 ppm, the average lifetime tends to end up deteriorating quite a bit. The reason is believed to be that the CuO segregates in the dielectric ceramic composition whereby the silver of the internal conductors easily diffuses into the dielectric ceramic position and, as a result, when plating the surfaces of the external electrodes, the plating solution invades the dielectric ceramic composition from the leadout parts of the internal electrodes thereby causing deterioration of the insulation. As opposed to this, in Example 2, a TiO₂ material containing SiO₂ in a content of 20 ppm was used, so the dielectric layers can be improved in sinterability, invasion of the plating solution can be effectively prevented, and as a result the average lifetime can be improved.

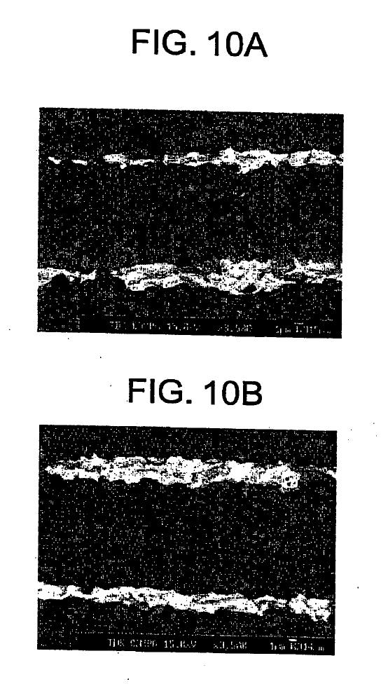

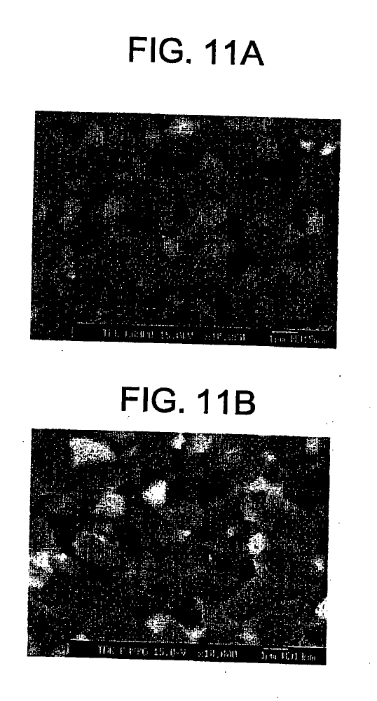

Note that FIG. 10A and FIG. 11A show photographs of the cross-sections of the dielectric layers of Example 2, while FIG. 10B and FIG. 11B show photographs of the cross-sections of the dielectric layers of Comparative Example 4. From these photographs, it can be confirmed that cared with the dielectric layers of Comparative Example 4, the dielectric layers of Example 2 are denser in structure.

1. A method of production of dielectric powder containing as main ingredients Ti, Cu, and Ni, comprising
a step of mixing an oxide of Ti and/or a compound forming an oxide of Ti by firing, an oxide of Cu and/or a compound forming an oxide of Cu by firing, and an oxide of Ni and/or a compound forming an oxide of Ni by firing to obtain a mixed powder,
a step of calcining said mixed powder to obtain a calcined powder,
a step of dry crushing said calcined powder to obtain dry crushed powder, and
a step of wet crushing said dry crushed powder.

2. The method of production of dielectric powder as set forth in claim 1, wherein said dry crushing is airflow crushing using high pressure air to crush said calcined powder.

3. The method of production of dielectric powder as set forth in claim 1, wherein a D90 size of said dry crushed powder after dry crushing is 0.60μm to 0.80 μm in range.

4. The method of production of dielectric powder as set forth in claim 2, wherein a D90 size of said dry crushed powder after dry crushing is 0.60 μm to 0.80 μm in range.

5. The method of production of dielectric powder as set forth in claim 1, wherein a D50 size of said dry crushed powder after dry crushing is 0.45 μm to 0.65 μm in range.

6. The method of production of dielectric powder as set forth in claim 2, wherein a D50 size of said dry crushed powder after dry crushing is 0.45 μm to 0.65 μm in range.

7. The method of production of dielectric powder as set forth in claim 1, wherein said dry crushed powder after dry crushing has a content of coarse particles having a 20 μm or more particle size, by weight ratio with respect to said dry crushed powder as a whole, of 50 ppm or less.

8. The method of production of dielectric powder as set forth in claim 2, wherein said dry crushed powder after dry crushing has a content of coarse particles having a 20 μm or more particle size, by weight ratio with respect to said dry crushed powder as a whole, of 50 ppm or less.

9. The method of production of dielectric powder as set forth in claim 1, wherein said oxide of Ti and/or compound forming an oxide of Ti by firing is one having a ratio of content of SiO₂ of 20 ppm or less.

10. The method of production of dielectric powder as set forth in claim 2, wherein said oxide of Ti and/or compound forming an oxide of Ti by firing is one having a ratio of content of SiO₂ of 20 ppm or less.

11. A method of production of a composite electronic device having a coil part comprised of coil conductors and ferromagnetic layers and a capacitor part comprised of internal electrodes and dielectric layers, comprising
a step of forming dielectric green sheets forming said dielectric layers after firing and
a step of firing a green chip containing said dielectric green sheets, wherein
the material forming said dielectric green sheets is a dielectric powder obtained by the method of claim 1.

12. The method of production of a composite electronic device as set forth in claim 11, wherein said dielectric green sheets have a thickness of 20 μm or less.

13. A method of production of a composite electronic device having a coil part comprised of coil conductors and ferromagnetic layers and a capacitor part comprised of internal electrodes and dielectric layers, comprising
a step of forming dielectric green sheets forming said dielectric layers after firing and
a step of firing a green chip containing said dielectric green sheets, wherein
the material forming said dielectric green sheets is a dielectric powder obtained by the method of claim 2.

14. A composite electronic device obtained by the method of claim 11, having
a coil part comprised of coil conductors and ferromagnetic layers and
a capacitor part comprised of internal electrodes and dielectric layers,
said dielectric layers containing as main ingredients an oxide of Ti, an oxide of Cu, and an oxide of Ni and having a thickness of 15 μm or less.

15. The composite electronic device as set forth in claim 14, wherein said dielectric layers have a content of SiO₂, by weight ratio with respect to said dielectric layers as a whole, of 200 ppm or less.

16. The composite electronic device as set forth in claim 14, wherein
said dielectric layers have an Ni dispersion of 80% or less, and
said dielectric layers are formed by dielectric crystal particles having an average crystal particle size of 2.5 μm or less and having a standard deviation a of distribution of crystal particle size of 0.5 μm or less.

17. The composite electronic device as set forth in claim 14, wherein said dielectric layers further contain an oxide of Ah, the content of said oxide of Mn being, with respect to said dielectric layers as a whole as 100 wt %, converted to MnO, more than 0 wt % to 3 wt %.

18. The composite electronic device as set forth in claim 14, wherein said ferromagnetic layers are comprised of an Ni—Cu—Zn-based ferrite or Cu—Zn-based ferrite.

19. A composite electronic device obtained by the method of claim 13, having
a-coil part comprised of coil conductors and ferromagnetic layers and
a capacitor part comprised of internal electrodes and dielectric layers,
said dielectric layers containing as main ingredients an oxide of Ti, an oxide of Cu, and an oxide of Ni and having a thickness of 15 μm or less.
